(19) United States
(12) Patent Application Publication
(10) Pub. No.: US 2019/0156350 A1
(43) Pub. Date: May 23, 2019

(54) SYSTEM AND METHOD FOR NEAR REAL-TIME ANALYSIS OF INTERESTS AND SENTIMENT

(71) Applicant: Colossio, Inc., Chicago, IL (US)

(72) Inventor: Joseph A. Jaroch, Chicago, IL (US)

(21) Appl. No.: 15/817,714

(22) Filed: Nov. 20, 2017

(51) Int. Cl. G06Q 30/02

(52) U.S. Cl. CPC G06Q 30/0201; G06Q 50/01

(57) ABSTRACT

A system for analyzing user sentiment includes one or more processors, one or more memory components, one or more network connections, and first and second databases. Further according to this aspect, the first database includes a plurality of concepts partially developed by processing a plurality of data repositories, and the second database includes a user record partially developed by processing data related to post content. Still further, the one or more processors search the second database by one or more interests to determine one or more user interest levels, and the one or more interests are correlated with one or more of the plurality of concepts.

### TECHNICAL FIELD

The present disclosure generally relates to sentiment tracking, and more specifically relates to a system and method for analyzing and organizing sentiment in connection with interests and/or brands in near real-time.

### BACKGROUND

Brand sentiment is a crucial tool for marketing organizations. Brand sentiment provides a window into customer opinion. Useful brand sentiment information may allow a business to stay ahead of issues related to the brand and associated organizations/products. Still further, carefully tracked brand sentiment may guide an organizational response should a crisis arise in connection with the brand.

However, given the current state of the art, sentiment typically consists of a retroactive opinion. In other words, sentiment can only be analyzed well after the fact and, perhaps, significantly removed from one or more incidents of importance. Currently, the computational complexity of gaining insight on a per-user level in near real-time is relatively very intensive.

To solve this challenge, the below disclosure sets forth systems and methods for analyzing and tracking brand sentiment in real-time or very near real-time. The systems and methods establish a concept of per-message metadata in social media. Still further, the systems and methods contemplated herein extract possible concepts/interests/entities and correlate sentiment with same. The sentiment(s), correlated with the one or more entities, are then available with timestamps for tracking historical trends in sentiment by user or in aggregate.

The description provided in the background section should not be assumed to be prior art merely because it is mentioned in or associated with the background section. The background section may include information that describes one or more aspects of the subject technology.

### SUMMARY

According to an aspect of the present disclosure, a system for analyzing user sentiment includes one or more processors, one or more memory components, one or more network connections, and first and second databases. Further according to this aspect, the first database includes a plurality of concepts partially developed by processing a plurality of data repositories, and the second database includes a user record partially developed by processing data related to post content. Still further, the one or more processors search the second database by one or more interests to determine one or more user interest levels, and the one or more interests are correlated with one or more of the plurality of concepts.

According to another aspect of the present disclosure, a system for tracking sentiment in near real-time includes a processor and a memory component operatively coupled to a network. Further in accordance with this aspect, a plurality of interests are stored on the memory component arranged according to a plurality of database identification numbers, and the system receives user content from a plurality of social media platforms. Still further, the system applies to the user content an organizational scheme based on the plurality of interests and the plurality of database identification numbers, and one or more user records are developed by the processor and stored on the memory component. Also in accordance with this aspect, the one or more user records represent chronologically organized sentiments of one or more users across the plurality of social media platforms.

According to yet another aspect of the present disclosure, a method for analyzing user sentiment includes receiving data from a plurality of web sources, performing natural language processing on the plurality of web sources, identifying n-grams corresponding to a plurality of interests within the web sources, and assigning one or more database identification numbers to the plurality of interests. Further in accordance with this aspect, the method includes receiving user content, organizing the user content chronologically according to a time period when the user content was generated by a user, and analyzing the user content to identify n-grams corresponding to the plurality of interests. Additionally, the method includes assigning to the user content the one or more database identification numbers depending on the n-grams identified within the user content, tracking a sentiment score of the user content when the one or more database identification numbers are identified within the user content, and developing one or more user records wherein the one or more database identification numbers, the sentiment scores, and timestamps correlating to receipt of the user content are saved together.

Other aspects and advantages of the present invention will become apparent upon consideration of the following detailed description and the attached drawings wherein like numerals designate like structures throughout the specification.

### BRIEF DESCRIPTION OF THE DRAWINGS

The accompanying drawings, which are included to provide further understanding and are incorporated in and constitute a part of this specification, illustrate disclosed embodiments and together with the description serve to explain the principles of the disclosed embodiments. In the drawings:

FIG. 1 illustrates an example system for analyzing user generated content and tracking sentiment related to particular interests;

FIG. 2 is a flowchart depicting an example process of the system of FIG. 1 according to certain aspects of the disclosure; and

FIG. 3 is a flowchart depicting another example process of the system of FIG. 1 according to certain aspects of the disclosure.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below is intended as a description of various implementations and is not intended to represent the only implementations in which the subject technology may be practiced. As those skilled in the art would realize, the described implementations may be modified in various different ways, all without departing from the scope of the present disclosure. Still further, modules and processes depicted may be combined, in whole or in part, and/or divided, into one or more different parts, as applicable to fit particular implementations without departing from the scope of the present disclosure. Accordingly, the drawings and description are to be regarded as illustrative in nature and not restrictive.

General Overview

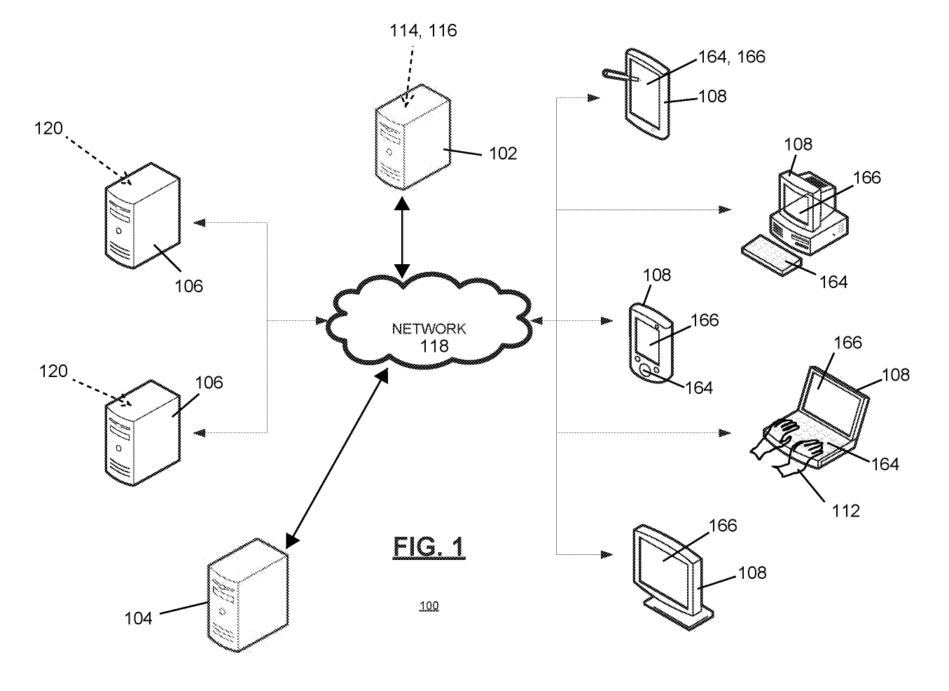

In one embodiment, a disclosed system 100 analyzes, identifies, and categorizes concepts referenced within a body of user generated data/content 110, see FIG. 1, while accounting for different words, grammar, slang, vocabulary, etc. of the language.

The system leverages a dictionary of words, slang, truncations, common names, etc. so as to identify concepts and/or interests within the user generated contents/text 110. This combined vocabulary allows the system 100 to process normal text, personal names, and proper nouns as a means of delineating unimportant text from brand names or interest-related data. The system 100 may iterate through the user generated content/text 110 while drawing upon an extensive database of concepts/interests 116.

This database 116 is prepared by mining data from large data repositories 120, such as Wikipedia, and training neural networks on each page thereof to identify n-grams of paramount relevance to each concept/interest. The concepts/interests are classified into a number of different categories for organization within the database 116. The categories may be based on common advertising categorization systems such as the Interactive Advertising Bureau (IAB) or another suitable classification/organization scheme. Still further, the concepts/interests may be classified according to more than one classification/organization scheme drawn from one or more platforms and relevant to one or more broad fields.

Due to the varied nature of speech, the database 116 includes a wide range of different terms for each concept/interest. For example, in connection with the concept/interest of basketball the database may associate the terms “basketball,” “shooting hoops,” and/or “bball.” All such related terms are associated with the same output category code because the meaning thereof is identical for the purpose of identifying interests/concepts. Therefore, when the user generated content/text 110 is analyzed, concepts/interests contained therein may be identified by all of the related terms, rather than by a subset thereof such as a single brand name.

As each word, name, brand, concept, and/or interest is found, it is stored in a user record 114 correlating to an individual user 112 responsible for creation of the user generated content/text 110. A count is maintained for each concept/interest found within the user generated content/text 110, and upon identification of an n-gram related to each particular concept/interest the respective count is incremented. Across a large number of messages, social media posts, e-mails, website submissions, etc., the user record 114 builds an increasingly precise view of the user's interests by identifying the frequency and timing of each mentioned concept/interest. In this way, the user record 114 supplies context for the user 112 and the user's account(s).

The system 100 may further provide for analysis of other user generated, web-accessible content such as academic research papers, press releases, corporate documentation, textbooks, blogs, personal or corporate webpages, and/or any other suitable content attributable to one or more users. However, exemplary embodiments of the system 100 are designed to function on smaller and less structured bodies of data like Tweets, Facebook posts, Instagram text, Snapchat text, Reddit posts, message board or comment section posts, chat application messages, e-mails, and other social media content.

Each entry in the user record 114 is also tagged an identification number representing the originating message so that the data from the original message can be used to further enhance insights about the interests mentioned within the message. A sentiment score of the overall message is used and correlated to each interest mentioned within the message. This allows a picture of interest sentiment over time to be built for each user.

The user record(s) 114 may be established during an initial historical “pull” of an entire user account history, including all posts associated with said account. Once established, the user record(s) 114 are stored persistently and revised as subsequent user content is received. Periodic snapshots of the user record 114 may be saved to memory, such as to a solid state drive or hard disk drive, at a configurable interval. For example, the user record(s) 114 may be saved following each update thereof.

To ensure maximum efficiency, each user record may retain the original extracted data and raw statistics about each interest/concept. Retention of this data requires relatively larger quantities of memory, but allows for flexible re-processing should the driving algorithms or database(s) 116 change.

The user record(s) 114 are refreshed in near real-time as new data is received. Newly received data may be batched together, and accordingly, the user record(s) 114 may be updated after a given (relatively short) period passes. Alternatively, a counter may track receipt of new user content and update the user record(s) 114 after a certain number of new messages, social media posts, e-mails, website submissions, etc. have been received either on a per user basis or aggregate across the users 112 with user records stored by the system 100. The setting of the update period and the determining of the counter threshold dictates the near real-time responsiveness of the system 100.

Marketing organizations, brand managers, researchers, and/or other interested entities may desire insight into brand sentiment. Consultation with the system 100 described herein will allow said entities to gain this insight quickly, accurately, and in near real-time. For example, the entities may identify user records that indicate usage of target products, based on the concepts/interests associated with the stored user record(s) 114. Furthermore, the entities may identify the user record(s) 114 with specific mentions of a target brand.

According to the previous state of the art, it has only been realistically possible to observe users who had messaged directly at a company (i.e., by a known hashtag or “@examplecompanyname”). The metadata of posts/messages directed to a company has been easily mined for data, such as the specific target of each post/message. However, scouring the metadata alone provides only a limited field for searching. Overall, the previous state of the art was less able to provide a complete picture of user interests and sentiments associated therewith. By contrast, the system 100 of the present disclosure searches for users who have passively mentioned “Example Company Name” in messages, social media posts, submissions, etc. This system, at least partially because of the concept/interest database categorization and preparation, extracts each interest, brand name, personal name, and other key categories for individual users. Thus, the system 100 provides deeper insight as compared with the high-level enumeration of received messages already well-known in the art.

The system also enables an entity to query the one or more user records 114 for messages referencing known competitors and/or suitable collaborators. This is possible because the data for each user 112 is pre-indexed and pre-analyzed regardless of the industry of interest. Still further, the categorization and organization of the one or more user records 114, as described hereinthroughout, may uncover subtle audience segmentation demographics. For example, proper querying and analysis of the one or more user records 114 may unveil that brand sentiment of a robotic vacuum fell after a recent software update because users who own dogs began experiencing problems with the robotic vacuum failing to sense, and consequently failing to properly avoid, the pets. This example illustrates gleaning the subtle demographic for whom a product or brand has resulted in negative sentiment, and further connects the negative sentiment to a likely cause.

The disclosed system 100 addresses a technical problem tied to computer technology and arising in the realm of computer networks, namely the technical problem of identifying key concepts/interests referenced within user generated content, such as social media posts, without such user generated content needing individual interpretation by human analysts. The disclosed system solves this technical problem by analyzing the one or more databases 120 (on one or more data repository servers 104) of possible information to identify data relevant to particular concepts and/or interests, and organizing such information according to a categorization scheme. Then the disclosed system 100 analyzes the received user generated content 110 to identify concepts/interests mentioned therein. The disclosed system 100 further stores in the user record(s) 114 the identified concepts/interests, a time period associated therewith, and the user sentiment further associated with the identified concepts/interests and the time period. The disclosed system 100 provides a solution necessarily rooted in computer technology as it relates to the analysis of bodies of data to identify, and obtain, suitable relevant information to categorize concepts/interests and thereafter identify same amongst the content generated 110 in user social media posts. The disclosed system 100 improves the way in which information available across plural networks, servers, and databases is analyzed, interpreted, and presented for use by an organization/brand/entity.

For example, the disclosed system 100 facilitates allowing user content or data to be analyzed, categorized, temporally organized, and stored in the one or more user records 114 available for query. As a result, a richer querying experience/tool may be provided with regard to obtaining relevant information, particularly user sentiment, in connection with any desired concept/interest/brand. In addition, the system 100 drastically reduces the processor, memory, and network bandwidth requirements necessary for providing, in near real-time, the most relevant content or data, such as broad user sentiment, associated with a specific concept/interest/brand, as well as providing for the gleaning of subtle audience segmentation demographics. The system 100 thereby improves the efficiency/speed of the computer and/or the network, as well as drastically improves the relevant information uncovered during queries directed at particular concepts/interests/brands. The system 100 improves the ability of an organization/brand/entity to track the historical sentiment associated with the relevant concept/interest/brand as well as follow individual or aggregate user sentiment in near real-time. Still further, the system 100 decreases the expense associated with transmitting and purchasing numerous queries to numerous respective individual social network APIs (application programming interfaces). Instead, the system 100 facilitates cross-platform searching and sentiment tracking. The concept/interest training portion of the system 100 also provides duality in that it not only identifies and analyzes user content directed, for example, at a specific brand, but also may determine alternative or related other concepts that are closely tied to the sentiment of the central concepts/interest/brand.

The system 100 described herein may be deployed on a very powerful server, in particular one with parallel processing capabilities and ample storage space. One or more graphics cards present in a system server 102 may be used as optimization tools for processing additional operations in parallel. Also, the generated workload may be optimally distributed across multiple different physical computers, i.e., a network of computers/servers. The storage and hosting of the data produced by the system 100 may be held locally or distributed across one or more remote datacenters, depending on storage requirements.

Example System Implementation

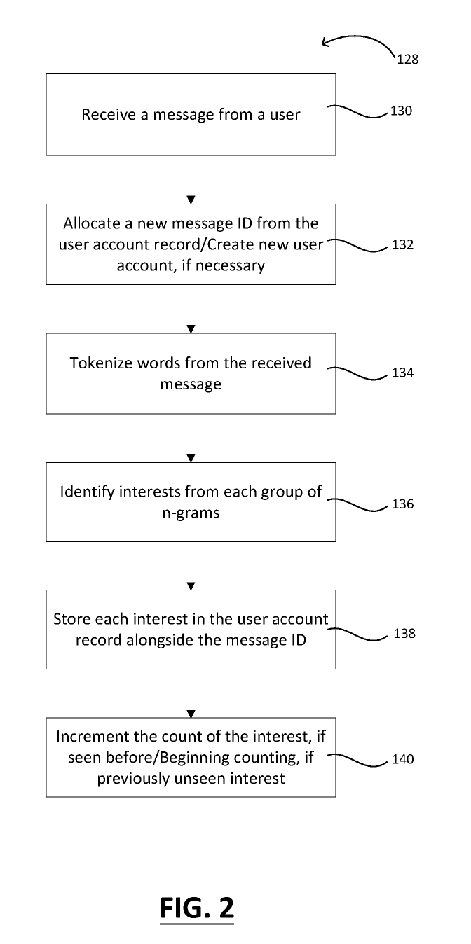

Referring now to FIG. 2, process 128, for analyzing incoming user generated content 110, is depicted. At step 130 of the process 128 user generated content 110, such as a message, group of messages, post, comment, and/or submission from a user 112 is received by the system 100. Following receipt, at step 132, the incoming user content 110 is assigned a message identification number used for adding the message and/or the information gleaned therefrom to the user record 114 associated with the individual message. If a user record has not yet been established for the user 112 responsible for creation of the content 110, then a user record is established for the creator of the newly received message. Message specific metadata, as described hereinbelow, is assigned the message identification number for storage and tracking purposes. According to an example embodiment, the message identification number may include a sequential ID indicating the total number of messages the user 112 has posted by the time said new message is posted and received by the system 100.

The user content 110 is tokenized into a group of words/n-grams during step 134. In computational linguistics, an n-gram is a contiguous sequence of n items from a given sequence of text or speech; in this case, user generated content. The n items may be phonemes, syllables, letters, words, base pairs, and/or some combination thereof.

The n-grams are searched and processed in a manner described in U.S. patent application Ser. No. 15/817,505, entitled “N-Gram Classification In Social Media Messages”, filed Nov. 20, 2017, the entirety of which is hereby incorporated by reference herein. In accordance with the systems and methods of the U.S. patent application indicated immediately above, the n-grams are processed to identify concepts, interests, and/or brands mentioned in each message of the user generated content 110.

Processing of the user content 110 develops metadata associated with each message, as mentioned hereinabove. The metadata may include identification of a concept, interest, and/or brand, user sentiment, and timestamp/time period data correlated with the generation or receipt of the message. This information is identified within the user generated content 110 at step 136. The n-grams of the user message are compared against the concepts/interests organized within the database 116 according to the general overview detailed hereinabove. The original contents of the user message may not be stored in the user record 114. Instead, the data retrieved from the methods and systems described in U.S. patent application Ser. No. 15/817,505, entitled “N-Gram Classification In Social Media Messages”, filed Nov. 20, 2017, mentioned hereinabove, is stored in the user record 110 at step 138.

The sequential ID, identifying from where in the total number of messages the metadata was extracted, is stored along with the metadata in the user record 114. The sequential ID, by virtue of the sequential relationship, may provide temporal information for historical and trend tracking of sentiment. Alternatively or in addition to the sequential ID, the metadata may include or be correlated with a timestamp reflecting the time at which the associated message was posted or when the user record(s) 114 were updated. The timestamp of each message may be saved into the user record(s) 114 alongside information on the concepts/interests and/or brands mentioned in that message.

The extracted concepts/interests may be further assigned a database identification number. The database identification number may indicate the specific concepts/interests/brands mentioned in the user message. In an example embodiment, the one or more database identification numbers may be assigned to the message, and stored in a message record, in order to identify a plurality of concepts/interests recognized within the particular user content 110. One or more database identification numbers may be stored in the user record 114 alongside the message identification number, sequential ID, and/or timestamp. Storage of this data may represent a significant efficiency gain as compared with storage of the full concept/interest data and/or the full user generated message. Additionally, the one or more database identification numbers may have counters associated therewith to track the frequency with which the concepts/interests are mentioned in the user generated content 110. Each time an instance of a particular concept/interest is recognized within a user message, the counter for that particular concept/interest is incremented. In accordance with the flow chart of FIG. 2, the counter(s) for one or more concepts/interests are incremented at step 140. Also at step 140, if a concept/interest has not been previously recognized among the incoming user content 110, then a counter is established for this newly recognized concept/interest. Counting the incidences of particular concepts/interests is useful for tracking the historical presence of such concepts/interests across multiple social media platforms, and more generally, within the consciousness of the aggregate user base.

It is possible that the database may change, such as from updates thereto. In the case of a database change/update, the stored user record does not need to be fully recomputed. Instead, a lookup of the superseded concept/interest database identification numbers is performed during the next update of the user record(s) 114. In other words, once a next message or group of messages is received and processed, during the storing of information to the user record(s) 114, updated database identification numbers may be replaced during the same operation when the system 100 compiles/stores the newly developed information.

User record(s) 114 are refreshed in near real-time as new data is received. Newly received data may be batched together, and accordingly, the user record(s) 114 may be updated after a given (relatively short) period passes. Alternatively, a received message counter may track receipt of new user content and update the user record 114 after a certain number of new messages, social media posts, e-mails, website submissions, etc. have been received either on a per user basis or aggregate across the users 112 with the user records 114 stored by the system 100. The setting of the update period and the determining of the counter threshold dictates the near real-time responsiveness of the system 100. In embodiments of the system 100, the user record(s) 114 may be updated whenever the user record(s) 114 are queried, alternative to or in addition to updating according to the update period.

Refreshing the user record(s) 114, involves re-iterating over the existing, stored records and building individualized, chronological histories of the interests and sentiments of each user 112. Historical users' views begin with the first instance of user generated content 110 and continue up to the latest post by the user 112. However, due to the sporadic nature of social media posting, the one or more user records 114 may have gaps therein that represent periods during which the user(s) 110 did not post or did not post enough to trigger updating of the user record(s). It is contemplated that the system 100 may account for the periods during which users have not produced user content during the generation of output, such as visual output, by the system 100.

During the steps 138, 140 of FIG. 2, a superset of the concepts/interests/brands appearing in the user generated content 110 is produced, and the frequency with which each of these are mentioned is calculated from the data stored in the user record(s) 114. This process may be carried out by the concept/interest designated counter(s) or by performing processing of the user record(s) 114. Concept/interest frequency may be analyzed on an aggregate or a per user basis, depending on the desired output of the system 100.

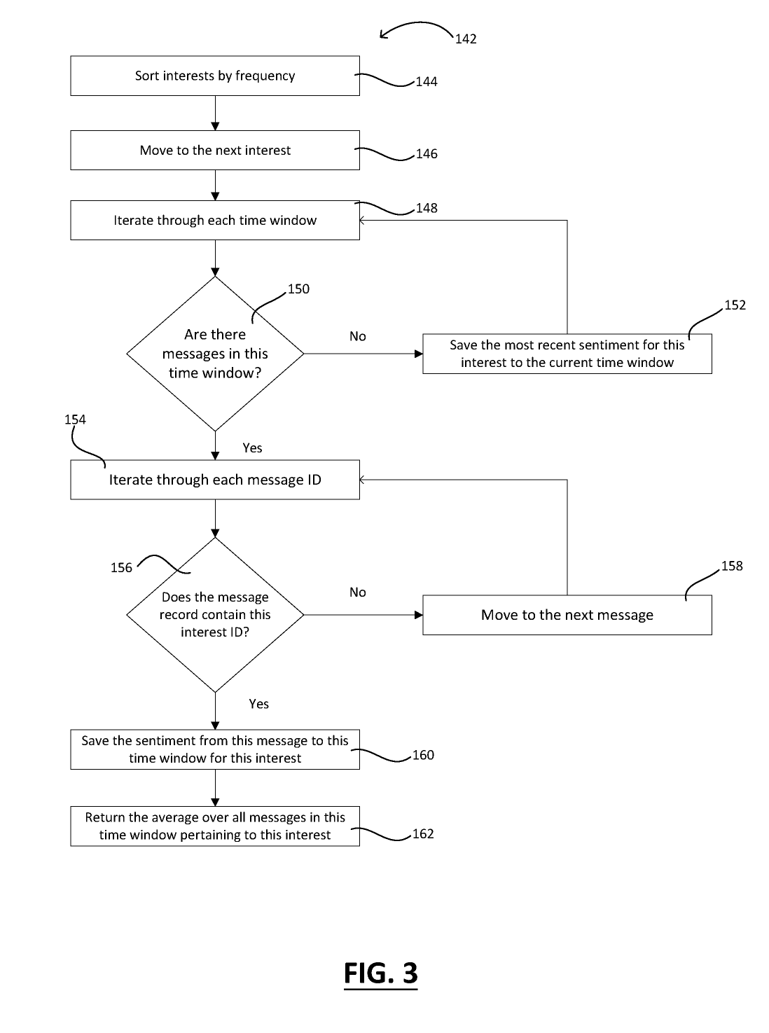

Referring now to FIG. 3, process 142, for analyzing user sentiment in user generated content 110, is depicted. The process 142 begins with step 144 wherein the concepts/interests, the appearance frequency of each having been previously recorded, are sorted according to frequency. Then at step 146, each of the concept(s)/interest(s) in the user record(s) 114 is selected as a subject of more detailed analysis. Upon selecting a concept/interest for closer analysis, each time period/window is examined individually at step 148, to determine the contents thereof; specifically, whether any user generated content 110 was received/generated during the respective time period.

At decision step 150, the process 142 determines whether the time period includes any messages, posts, and/or other user generated content 110. If the answer to decision step 150 is “no,” then the previous, most recent sentiment for the concept/interest (i.e., the sentiment gleaned from the most recent earlier incidence of the subject concept/interest) being analyzed is retained. Therefore, the previous sentiment for the concept/interest is saved in correlation with the time period currently being analyzed, at step 152. In this way, if no messages were posted in a particular chronological window/time period, the previous sentiment score is returned for the intervening time periods. Sentiment scores are generally scored on a continuum from −1 to 1, with the distance from zero indicating the strength of the score and zero or near-zero indicating a neutral sentiment. For example, 1 may indicate strongly positive sentiment, −1 may indicate strongly negative sentiment, and 0.1 may indicate weakly positive sentiment. Following the saving of the previous sentiment in connection with the subject concept/interest at step 152, the process 142 returns to step 140 so as to iterate to the next time period in search of a next sentiment expressed by the user content 110.

However, when decision step 150 identifies one or more messages within the subject time period, the process 142 moves to analysis step 154. During the analysis step 154, process 142 iterates through each of the one or more message identification numbers present during the subject time period. For each message identification number recognized within the time period, decision step 154 accepts the message identification number, correlates the message identification number with the respective message it represents, and analyzes the message for the subject concept/interest. In an example embodiment, the entirety of each message is not analyzed. Instead, the message identification number corresponds to a message record. The message record includes database identification numbers that identify concepts/interests, as detailed hereinabove. The system 100 checks each message record for the database identification numbers correlated with the subject concept/interest of step 146.

If, at the decision step 156, the message or message record does not contain the subject concept/interest, then the system 100 moves to the next message present during the current time period by way of step 158. Here the process 142, is returned by step 158 to step 154 so as to iterate to the next message within the time period being currently examined.

Instead, if the decision step 156 results in the recognition of the subject concept/interest in the message or message record, then the process moves to storage step 160. At storage step 160 the sentiment contained in the current message is saved with the corresponding time period and the subject concept/interest. When the concept/interest/brand is found, the sentiment of the broader message containing the concept/interest/brand is stored in the user record 114 chronologically. In example embodiments, the storage step 160 executes a save of the above-identified data to the user record 114. Alternatively, this information may be stored in another type of record such as one or more aggregation records directed to the subject concept/interest, a particular window of time, or a subset of users.

Step 162 produces an output for process 142. According to an embodiment, the average sentiment from all of the examined messages pertaining to the subject concept/interest during a particular time window is returned. This output may facilitate a view of the overall sentiment concerning the concept/interest at a given time, such as during the immediate past. In this way, the system 100 is able to provide snapshots of user sentiment in near real-time. The resultant output represents a chronological view into the concepts/interests about which the user 112 is enthused. The output depicts a “mindshare” of user interests based on their mentioning frequency, and the sentiment of those interests, based on the sentiment of the messages in which the concepts/interests were posted. This output may be visualized in a graphical format, e.g., a graph, chart, table, etc. The output may also be produced in a computationally consumable format such as a JSON (JavaScript Object Notation) file, XML, and/or another suitable format. The system 100 may use Google Charts, D3, or other third-party chart/graph generation tools capable of consuming the data produced by the system and outputting same in a visual form that is easily consumable by a person.

Example System Architecture

Architecturally, the representative technology can be deployed anywhere. For example, it may be preferable to operate on a server with a significant amount of computing power, as noted hereinabove, due to the computation that needs to occur to build and access the concept/interest databases and process the user generated content 110 in real-time or near real-time.

The interest/concept database may be stored in a flat, binary structure, such as My SQL, NoSQL, or SQL, for example.

Example embodiments of the disclosed system 100 are described hereinthroughout with reference to FIGS. 1-3 which illustrate the system 100 and its processes 128, 142, which, taken together, illustrate the subject of this disclosure. While the example processes 128, 142 of FIGS. 1 and 2 are described with reference to FIG. 1, it should be noted that steps of the processes 128, 142 may be performed by other systems including systems having more or fewer parts relative the system 100 of FIG. 1. In certain aspects, the system 100 may be implemented using hardware or a combination of software and hardware, either in a dedicated server or integrated into another entity or distributed across multiple entities. The system 100 may include illustrative primary architectural/hardware components including the at least one system server 102, the at least one data repository server 104, and the at least one social media server 106. The user device(s) 108 may be, for example, desktop computers, mobile computers, tablet computers (e.g., including e-book readers), mobile devices (e.g., a smartphone or personal digital assistant), set top boxes (e.g., for a television), video game consoles, or any other devices having appropriate processor, memory, and communications capabilities for generating user content. The system 100 queries resources over the network 118 from one of the server(s) 104, 106, and/or the user device(s) 108 directly.

The server(s) 102, 104, 106 may comprise one or more servers and/or associated computing devices including backend application servers (i.e., webserver), database servers, network servers, and API hosts. One or more of the servers 102, 104, 106 are configured to host various databases that include actions, documents, graphics, files, and any other sources of data. The databases may include, for each source in the database, information on the relevance or weight of the source of the data. For purposes of load balancing, multiple servers 102 may host the system server 102 and/or database(s) either individually or in portions.

The system server(s) 102 may be any device having an appropriate processor, memory, and communications capability for hosting content and information. The network 118 may include, for example, any one or more of a personal area network (PAN), a local area network (LAN), a campus area network (CAN), a metropolitan area network (MAN), a wide area network (WAN), a broadband network (BBN), the Internet, and the like. Further, the network 118 may include, but is not limited to, any one or more of the following network topologies, including a bus network, a star network, a ring network, a mesh network, a star-bus network, tree or hierarchical network, and the like.

The embodiment(s) detailed hereinabove may be combined in full or in part, with any alternative embodiment(s) described.

### INDUSTRIAL APPLICABILITY

An example embodiment and application of the system 100, may involve an organization in the business of producing and marketing robotic vacuums. This organization may wish to understand what their customers think about competitors to the organization and how customer thoughts have changed over time. The organization inputs social media posts from their customers into the system 100, or, alternatively, directs the collection of such social media posts according to particular criteria. In response to the collection and processing of the user social media posts, the system produces individually-generated graphs for each of the users/customers, showing all of the interests and brands mentioned by the users/customers in social media posts/messages. The graphical output developed by the system 100 visualizes, in an easily digestible way, that many of the users/customers following the organization have pets, in particular, dogs.

The output indicates how the sentiment of the dog-owning user/customers changes over time. Further it is apparent to the organization that changes in the sentiment of the dog-owning user/customers correlates with relative accuracy to certain organizational metrics including, for example, product release cycles, customer support cases, and other internal measurements. These correlations help the organization to understand how certain changes are impacting the public perception of the organization and its business ventures.

The organization identifies that a recent software update that was pushed out to the devices of a small number of users/customers mistakenly changed how the robotic vacuums recognize dogs. The errant software update resulted in the users/customers with dogs indicating frustration with the robot vacuum product. With the help of the insights provide by the system, the organization may now make a very narrowly focused change before more customers become frustrated. Use of these subtle audience segmentation demographics allows the organization to streamline a process that would have ordinarily required significant manual effort and human labor hours directed to identifying users and polling for user opinion.

The present disclosure details numerous example subsystems and subcomponents involved in tracking the sentiment of one or more users as it is associated with one or more concepts, interests, brands, organizations, people, parties, institutions, or the like. The detailed analysis of the user sentiments may include, amongst the user records, interests, preferences, attributes (e.g. age, gender, salary, location), and overall affinity categorizations of the user. Moreover, the detailed analysis may produce useful information, including that previously mentioned, for audience segmentation and marketing purposes.

System 100 includes a network or other communication mechanism for communicating information, and a processor in one or more of the server(s) 102, 104, 106. According to one aspect, the system 100 is implemented as one or more special-purpose computing devices. The special-purpose computing device may be hard-wired to perform the disclosed techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques. By way of example, the system 100 may include one or more processor(s) such as a general-purpose microprocessor, a microcontroller, a Digital Signal Processor (DSP), an ASIC, a FPGA, a Programmable Logic Device (PLD), a controller, a state machine, gated logic, discrete hardware components, or any other suitable entity that can perform calculations or other manipulations of information.

The system 100 may include, in addition to hardware, code that creates an execution environment for the computer program in question, e.g., code that constitutes processor firmware, a protocol stack, a database management system, an operating system, or a combination of one or more of them stored in an included memory, such as a Random Access Memory (RAM), a flash memory, a Read Only Memory (ROM), a Programmable Read-Only Memory (PROM), an Erasable PROM (EPROM), registers, a hard disk, a removable disk, a magnetic disk, an optical disk, a CD-ROM, a DVD, or any other suitable storage device, coupled to the system server(s) 102 and the network 118 for storing information and instructions to be executed by the one or more processor(s). The processor(s) and the memory may be supplemented by, or incorporated in, special purpose logic circuitry. Expansion memory may also be provided and connected to the system 100 through one or more of the system server(s) 102, which may include, for example, a SIMM (Single In Line Memory Module) card interface. Such expansion memory may provide extra storage space for system 100 or may also store applications or other information. Specifically, expansion memory may include instructions to carry out or supplement the processes described above and may further store secure information. Thus, for example, expansion memory may be provided as a security module for the system 100 and may be programmed with instructions that permit secure use of the system 100. In addition, secure applications may be provided via the SIMM cards, along with additional information, such as placing identifying information on the SIMM card in a non-hackable manner.

The instructions may be stored in memory and implemented in one or more computer program products, i.e., one or more modules of computer program instructions encoded on a computer readable medium for execution by, or to control the operation of, the system 100, and according to any method well known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, wirth languages, embeddable languages, and xml-based languages. Memory may also be used for storing temporary variable or other intermediate information during execution of instructions.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by the communication network 118. The processes and logic flows described in this specification can be performed by one or more programmable processors executing one or more computer programs to perform functions by operating on input data and generating output.

The components of the system can be interconnected by any form or medium of digital data communication, e.g., a communication network. The communication network (e.g., network 118) can include, for example, any one or more of a PAN, a LAN, a CAN, a MAN, a WAN, a BBN, the Internet, and the like. Further, the communication network can include, but is not limited to, for example, any one or more of the following network topologies, including a bus network, a star network, a ring network, a mesh network, a star-bus network, tree or hierarchical network, or the like.

For example, in certain aspects, the system 100 may be in two-way data communication via a network link that is connected to a local network. Wireless links and wireless communication may also be implemented. Wireless communication may be provided under various modes or protocols, such as GSM (Global System for Mobile Communications), Short Message Service (SMS), Enhanced Messaging Service (EMS), or Multimedia Messaging Service (MMS) messaging, CDMA (Code Division Multiple Access), Time division multiple access (TDMA), Personal Digital Cellular (PDC), Wideband CDMA, General Packet Radio Service (GPRS), or LTE (Long-Term Evolution), among others. Such communication may occur, for example, through a radio-frequency transceiver. In addition, short-range communication may occur, such as using a BLUETOOTH, WI-FI, or other such transceiver.

In any such implementation, server(s) 102, 104, 106 and user device(s) 108 send and receive electrical, electromagnetic or optical signals that carry digital data streams representing various types of information. The network link typically provides data communication through one or more networks to other data devices. For example, the network 118 may provide a connection through local network to a host computer or to data equipment operated by an Internet Service Provider (ISP). The ISP in turn provides data communication services through the world wide packet data communication network now commonly referred to as the Internet. The local network and Internet both use electrical, electromagnetic or optical signals that carry digital data streams. The signals propagated through the various components of the network 118, which carry the digital data betwixt and between elements of the system 100, are example forms of transmission media.

In certain aspects, the system server(s) 102, 104, 106 and/or user devices 108 are configured to connect to a plurality of devices, such as an input device 164 (e.g., keyboard) and/or an output device/display 166 (e.g., touch screen). For example, the input device 164 may include a stylus, a finger, a keyboard and a pointing device, e.g., a mouse or a trackball, by which a user can provide input to the system 100. The user device(s) 108 may include input devices used to provide for interaction with the user(s) 112, such as a tactile input device, visual input device, audio input device, or brain-computer interface device. For example, input from the user can be received in any form, including acoustic, speech, tactile, or brain wave input. Example output devices 166 include display devices, such as a LED (light emitting diode), CRT (cathode ray tube), LCD (liquid crystal display) screen, a TFT LCD (Thin-Film-Transistor Liquid Crystal Display) or an OLED (Organic Light Emitting Diode) display, for displaying information to the user(s) 112. The output devices/displays 164 may comprise appropriate circuitry for driving the user device(s) 108 to present graphical and other information to the user(s) 112.

According to one aspect of the present disclosure, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components.

As discussed hereinabove, the system may include clients and servers. A client and server are generally remote from each other and typically interact through a communication network. The relationship of client and server arises by virtue of computer programs running on the respective computers and having a client-server relationship to each other. The system may include, for example, and without limitation, a desktop computer, laptop computer, or tablet computer. The system may also be, in whole or in part, embedded in another device, for example, and without limitation, a mobile telephone, a personal digital assistant (PDA), a mobile audio player, a Global Positioning System (GPS) receiver, a video game console, and/or a television set top box.

The term “machine-readable storage medium” or “computer-readable medium” as used herein refers to any medium or media that participates in providing instructions or data to processors of the system for execution. The term “storage medium” as used herein refers to any non-transitory media that store data and/or instructions that cause a machine to operate in a specific fashion. Such a medium may take many forms, including, but not limited to, non-volatile media, volatile media, and transmission media. Non-volatile media include, for example, optical disks, magnetic disks, or flash memory, such as might be utilized by the client(s) and/or server(s). Volatile media include dynamic memory may also be used. Transmission media include coaxial cables, copper wire, and fiber optics, including the wires that comprise portions of the network. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read/be instructed. The machine-readable storage medium can be a machine-readable storage device, a machine-readable storage substrate, a memory device, a composition of matter affecting a machine-readable propagated signal, or a combination of one or more of them.

As used in the specification of this application, the terms “computer-readable storage medium” and “computer-readable media” are entirely restricted to tangible, physical objects that store information in a form that is readable by a computer. These terms exclude any wireless signals, wired download signals, and any other ephemeral signals. Storage media is distinct from but may be used in conjunction with transmission media. Transmission media participates in transferring information between storage media. For example, transmission media includes coaxial cables, copper wire and fiber optics. Transmission media can also take the form of acoustic or light waves, such as those generated during radio-wave and infra-red data communications. Furthermore, as used in this specification of this application, the terms “computer”, “server”, “processor”, and “memory” all refer to electronic or other technological devices. These terms exclude people or groups of people. For the purposes of the specification, the terms display or displaying means displaying on an electronic device.

In one aspect, a method may be an operation, an instruction, or a function and vice versa. In one aspect, a clause or a claim may be amended to include some or all of the words (e.g., instructions, operations, functions, or components) recited in either one or more clauses, one or more words, one or more sentences, one or more phrases, one or more paragraphs, and/or one or more claims.

To illustrate the interchangeability of hardware and software, items such as the various illustrative blocks, modules, components, methods, operations, instructions, and algorithms have been described generally in terms of their functionality. Whether such functionality is implemented as hardware, software or a combination of hardware and software depends upon the particular application and design constraints imposed on the overall system. Skilled artisans may implement the described functionality in varying ways for each particular application.

Headings and subheadings, if any, are used for convenience only and do not limit the invention. The word exemplary is used to mean serving as an example or illustration.

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

To the extent that the terms “include,” “have,” or the like is used in the description or the claims, such terms are intended to be inclusive in a manner similar to the term “comprise” as “comprise” is interpreted when employed as a transitional word in a claim. Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

Relational terms such as first and second and the like may be used to distinguish one entity or action from another without necessarily requiring or implying any actual such relationship or order between such entities or actions. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces. If there is any conflict in the usages of a word or term in this specification and one or more patent or other documents that may be incorporated herein by reference, the definitions that are consistent with this specification should be adopted.

A reference to an element in the singular is not intended to mean “one and only one” unless specifically stated, but rather “one or more.” The term “some” refers to one or more. Underlined and/or italicized headings and subheadings are used for convenience only, do not limit the subject technology, and are not referred to in connection with the interpretation of the description of the subject technology. Relational terms such as first and second and the like may be used to distinguish one entity or action from another without necessarily requiring or implying any actual such relationship or order between such entities or actions. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed, to achieve desirable results. The actions recited in the claims can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

The disclosed systems and methods are well adapted to attain the ends and advantages mentioned as well as those that are inherent therein. The particular implementations disclosed above are illustrative only, as the teachings of the present disclosure may be modified and practiced in different but equivalent manners apparent to those skilled in the art having the benefit of the teachings herein. Furthermore, no limitations are intended to the details of construction or design herein shown, other than as described in the claims below. The systems and methods illustratively disclosed herein may suitably be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range are specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

In one aspect, a term coupled or the like may refer to being directly coupled. In another aspect, a term coupled or the like may refer to being indirectly coupled. Terms such as top, bottom, front, rear, side, horizontal, vertical, and the like refer to an arbitrary frame of reference, rather than to the ordinary gravitational frame of reference. Thus, such a term may extend upwardly, downwardly, diagonally, or horizontally in a gravitational frame of reference.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout the disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for”.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. The method of disclosure is not to be interpreted as reflecting an intention that the claimed subject matter requires more features than are expressly recited in each claim. Rather, as the claims reflect, inventive subject matter lies in less than all features of a single disclosed configuration or operation. The claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “said” and similar references in the context of describing the invention (especially in the context of the following claims) are to be construed to cover both the singular and the plural, unless otherwise indicated herein or clearly contradicted by context. An element proceeded by “a,” “an,” “the,” or “said” does not, without further constraints, preclude the existence of additional same elements. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the disclosure and does not pose a limitation on the scope of the disclosure unless otherwise claimed. No language in the specification should be construed as indicating any non-claimed element as essential to the practice of the disclosure.

Numerous modifications to the present disclosure will be apparent to those skilled in the art in view of the foregoing description. Preferred embodiments of this disclosure are described herein, including the best mode known to the inventors for carrying out the disclosure. It should be understood that the illustrated embodiments are exemplary only, and should not be taken as limiting the scope of the disclosure.

What is claimed is:

1. A system for analyzing user sentiment, comprising:
one or more processors;
one or more memory components;
one or more network connections; and
first and second databases;
wherein the first database includes a plurality of concepts partially developed by processing a plurality of data repositories;
wherein the second database includes a user record partially developed by processing data related to post content;
wherein the one or more processors search the second database by one or more interests to determine one or more user interest levels; and
wherein the one or more interests are correlated with one or more of the plurality of concepts.

2. The system of claim 1, wherein the post contents processed to develop the second database are from a plurality of social media platforms.

3. The system of claim 2, wherein the post content comprises text posted by a user.

4. The system of claim 3, wherein the post content further comprises images or links posted by a user.

5. The system of claim 2, wherein the user record is updated in near real-time.

6. The system of claim 5, wherein the second database includes a plurality of user records partially developed by processing the data related to the post content;
wherein the plurality of user records are updated in near real-time; and
wherein the one or more processors search the second database to determine one or more aggregate user interest levels.

7. The system of claim 5, further comprising a post counter;
wherein the post counter is advanced as post content is submitted by one or more users; and
wherein the plurality of user records are updated when the post counter reaches a threshold level.

8. The system of claim 2, wherein the first database is arranged according a plurality of category codes.

9. The system of claim 8, wherein the category codes are extracted from the plurality of data repositories; and
wherein the plurality of data repositories are drawn from one or more web accessible databases.

10. The system of claim 9, wherein the category codes are applied across the plurality of data repositories to develop the plurality of concepts.

11. A system for tracking sentiment in near real-time, comprising:
a processor;
a memory component; and
wherein the system is operatively coupled to a network;
wherein a plurality of interests are stored on the memory component;
wherein the plurality of interests are arranged according to a plurality of database identification numbers;
wherein the system receives user content from a plurality of social media platforms;
wherein the system applies to the user content an organizational scheme based on the plurality of interests and the plurality of database identification numbers;
one or more user records developed by the processor and stored on the memory component;
wherein the one or more user records represent chronologically organized sentiments of one or more users across the plurality of social media platforms.

12. The system of claim 11, wherein one or more user interests are identified within the user contents;
wherein the one or more user sentiments are identified within the user contents;
wherein the one or more user interests are correlated with the respective one or more user sentiments; and
wherein the one or more user interests and the one or more user sentiments are stored in the one or more user records.

13. The system of claim 12, further comprising a counter that increments upon each receipt of the user content; and wherein the one or more user records are updated and the counter is restarted when the counter reaches a threshold.

14. The system of claim 13, wherein each of the one or more user records includes one or more user interests with the respective one or more user sentiments;
wherein a time period exists between instances of the counter reaching the threshold; and
wherein each of the one or more user records further correlates the one or more user interests and the one or more user sentiments with the time period during which the respective user interests and user sentiments were received.

15. The system of claim 11, wherein a query is conducted on the one or more user records; and
wherein the query is conducted according to one or more of the following: the database identification numbers and a timestamp.

16. The system of claim 15, wherein the query is conducted across platforms.

17. A method for analyzing user sentiment, comprising:
receiving data from a plurality of web sources;
performing natural language processing on the plurality of web sources;
identifying n-grams corresponding to a plurality of interests within the web sources;
assigning one or more database identification numbers to the plurality of interests;
receiving user content;
organizing the user content chronologically according to a time period when the user content was generated by a user;
analyzing the user content to identify n-grams corresponding to the plurality of interests;
assigning to the user content the one or more database identification numbers depending on the n-grams identified within the user content;
tracking a sentiment score of the user content when the one or more database identification numbers are identified within the user content;
developing one or more user records wherein the one or more database identification numbers, the sentiment scores, and timestamps correlating to receipt of the user content are saved together.

18. The method of claim 17, further comprising:
querying the one or more user records according to a combination of one or more database identification numbers and one or more of the timestamps.

19. The method of claim 18, further comprising:
updating the one or more user records when a threshold amount of new user content has been received.

20. The method of claim 19, further comprising:
updating the one or more user records when the one or more user records are queried.
